(19) United States
(12) Patent Application Publication
(10) Pub. No.: US 2004/0252996 A1
(43) Pub. Date: Dec. 16, 2004

(54) Flexible banded MUX/DEMUX architecture for WDM systems

(75) Inventor: John D. McNicol, Ottawa (CA)

Correspondence Address: Ogilvy Renault, Suite 1600, 1981 McGill College Avenue, Montreal, QC, H3A 2Y3, CA

(73) Assignee: Nortel Networks Limited

(21) Appl. No.: 10/457,555

(22) Filed: Jun. 10, 2003

(51) Int. Cl. H04J 14/02

(52) U.S. Cl. 398/79

(57) ABSTRACT

A method of conveying a WDM optical signal through a WDM system includes demultiplexing the received WDM optical signal into two or more spectral bands. Each spectral band has a respective predetermined center frequency and bandwidth, which encompasses a respective portion of the transmission window of a communications link. Each spectral band is then independently conveyed through the WDM system. This arrangement provides a flexible banded MUX/DEMUX architecture that enables multiple different channel plans (spectral grids) to co-exist within a common optical communications network. Legacy equipment can therefore continue in service, as traffic is gradually migrated onto new, higher capacity systems. This provides a convenient migration path for network service providers to progressively upgrade the information carrying capacity of network links, without stranding legacy equipment.

### CROSS-REFERENCE TO RELATED APPLICATIONS

This is the first application filed for the present invention.

### MICROFICHE APPENDIX

Not Applicable.

### TECHNICAL FIELD

The present invention relates to optical communications systems, and in particular to a flexible banded MUX/DEMUX architecture for Dense Wavelength Division Multiplexed (WDM) optical communications systems.

### BACKGROUND OF THE INVENTION

Wavelength division multiplexing (WDM) is a commonly used technique that allows the transport of multiple optical signals through an optical fibre. By conveying each of the optical signals using respective different channel wavelengths, wavelength division multiplexing enables a single fibre to carry vastly greater traffic volumes than would otherwise be possible. Typically, the channel wavelengths are concentrated within a transmission window near 1550 nanometres, in order to exploit low optical attenuation at those wavelengths. For example, the International Telecommunications Union (ITU) has defined a standard grid of channel wavelengths within a transmission window spanning a wavelength range of 1530-1612 nanometres. According to the current ITU standard, channel wavelengths are arranged on a 100 GHz grid. Consequently, the channel spacing for most installed WDM systems is 100 GHz, which is equivalent to 0.8 nanometres at a channel wavelength of 1552 nanometres. This channel spacing yields a spectral efficiency of only 10% at a channel bit rate of 10 gigabits per second.

Clearly, it is advantageous to carry as much information as possible within the available transmission window. Maximizing the information carrying capacity of the link is equivalent to maximizing the spectral efficiency of each channel and may be accomplished by increasing the line rate and/or reducing the channel spacing. To this end, the ITU has recently specified a spectral grid in which the wavelength channels are arranged at a spacing of 50 GHz. The use of this channel spacing in combination with a bit rate of 40 gigabits per second has the potential of increasing the spectral efficiency to 80%. WDM systems designed to multiplex and demultiplex wavelength channels arranged on this 50 GHz spectral grid are currently being deployed within the optical communications network. Further increases in spectral density, including a spectral grid having a 25 GHz channel spacing, are contemplated.

The demultiplexing of optical channels from a WDM signal is typically accomplished using a cascade of wavelength selective narrow-band filters, such as Array Wave Guide (AWG) or Fibre Brag Grating (FBG) filters. Each filter operates to extract light within a narrow band centered about a predetermined filter wavelength, which is chosen to correspond to a specific channel wavelength. A limitation of this approach is that a respective unique filter must be designed for each channel. This dramatically increases the cost of designing and installing network equipment.

Applicant's co-pending International Patent Application No. PCT/CA02/00452, entitled High Spectral Efficiency, High Performance Optical Mux and Demux architecture, discloses a system for reducing the cost of filter-based mux/demux systems. As shown in FIGs. 1a and 1b, the high performance Mux/Demux architecture 2 comprises a multi-layer architecture of cascaded demultiplexers. A group demultiplexer 4 utilizes a set of broadband optical filters (not shown) designed to separate respective predetermined channel groups 6 from a received WDM signal 8. In order to avoid crosstalk between adjacent channel groups 6, it is convenient to provide a “deadband” 10 between each group. If desired, various optical devices (not shown) such as amplifiers, variable optical attenuators etc., can be provided to independently control gain of each group 6. A set of channel demultiplexers 12 utilize narrow-band optical filters (not shown) to separate the individual channels 14 within each group 6. Using the standard ITU 50 GHz channel spacing, this arrangement yields the spectral grid shown in FIG. 1b, in which the transmission window is divided into 500 GHz wide channel groups 6 of eight channels 14 each arranged on a 50 GHz spacing, and separated by 100 GHz wide deadbands 10.

With this arrangement, identical group demultiplexers 4 can be provided in each node of the network, in order to consistently separate the channel groups 6 of respective inbound WDM signals 8. Furthermore, by suitably selecting the group width and channel wavelengths, it is possible to design narrowband optical filters such that the pass band of each narrow-band filter corresponds with a single channel 14 of each group 6. As described PCT/CA02/00452, this effectively renders the narrow-band filters “colorless”, so that identical channel demultiplexers 12 can be used to demultiplex each channel group 6. Consequently, economies of scale can be exploited to obtain a significant cost reductions over conventional systems.

However, a disadvantage of the above system is that, as with conventional filter-based mux/demux architectures, the channel plan is tightly coupled to the filter design. This means that changes in the channel plan necessarily requires modification or replacement of every involved network node. This can lead to legacy equipment being “stranded” as new network equipment is deployed, which creates a serious impediment to upgrades of the communication system.

Accordingly, a cost effective technique that enables a network service provider to progressively upgrade network links, without stranding legacy equipment, remains highly desirable.

### SUMMARY OF THE INVENTION

An object of the present invention is to provide a method and apparatus that enables different spectral grids to co-exist within a common link of an optical communications network.

Accordingly, the present invention provides a WDM system which comprises a coarse demultiplexer layer and a fine demultiplexer layer. The coarse demultiplexer layer separates two or more spectral bands from a broadband WDM optical signal, each spectral band including a plurality of multiplexed channels. The fine demultiplexer layer separates the respective channels of each spectral band. A respective spectral grid of a first spectral band is different from that of at least one other spectral band.

Thus the present invention provides a flexible banded MUX/DEMUX architecture that enables multiple different channel plans (spectral grids) to co-exist within a common optical communications network. Legacy equipment can therefore continue in service, as traffic is gradually migrated onto new, higher capacity systems. This provides a convenient migration path for network service providers to progressively upgrade the information carrying capacity of network links, without stranding legacy equipment.

### BRIEF DESCRIPTION OF THE DRAWINGS

Further features and advantages of the present invention will become apparent from the following detailed description, taken in combination with the appended drawings, in which:

FIG. 1a is a block diagram schematically illustrating elements of a conventional WDM communications system;

FIG. 1b schematically illustrates a conventional WDM spectral grid;

FIG. 2 is a block diagram schematically illustrating elements of a flexible banded MUX/DEMUX architecture in accordance with a first embodiment of the present invention;

FIGS. 3a-3c schematically show operation of the banded MUX/DEMUX architecture of FIG. 2;

FIG. 4 is a block diagram schematically illustrating elements of a flexible banded MUX/DEMUX architecture in accordance with a second embodiment of the present invention;

FIGS. 5a-5c schematically show operation of the banded MUX/DEMUX architecture of FIG. 4;

FIG. 6 is a block diagram schematically illustrating elements of a flexible banded MUX/DEMUX architecture in accordance with a third embodiment of the present invention; and

FIG. 7a-7d schematically show operation of the banded MUX/DEMUX architecture of FIG. 6.

It will be noted that throughout the appended drawings, like features are identified by like reference numerals.

### DETAILED DESCRIPTION OF THE PREFERRED EMBODIMENT

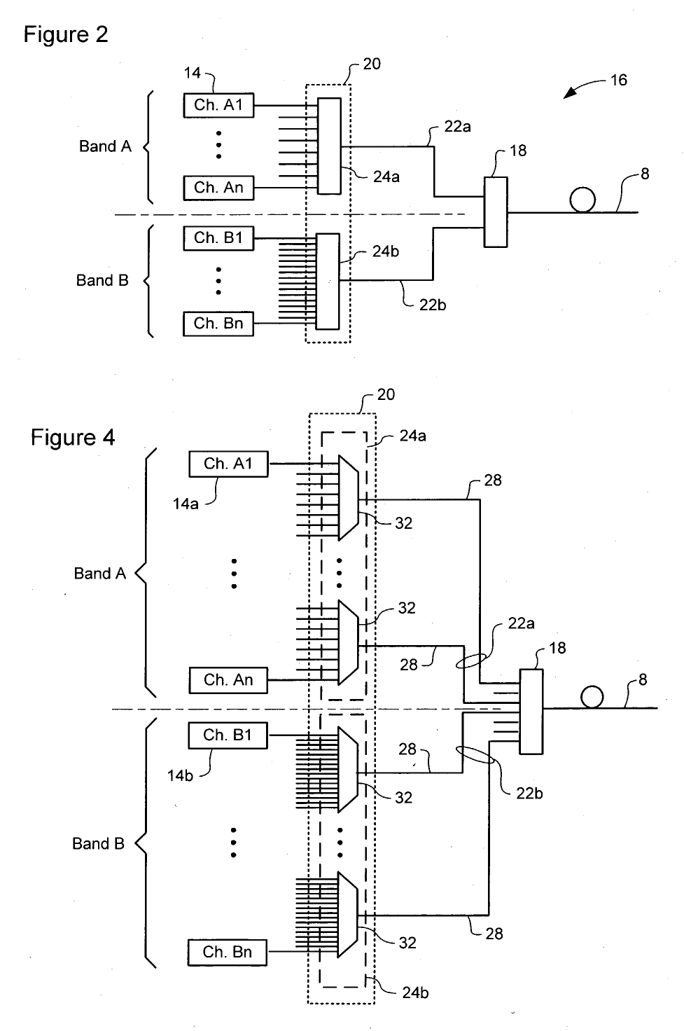

The present invention facilitates migration of the installed optical communications network by providing a flexible banded MUX/DEMUX architecture that enables multiple different spectral grids to co-exist on a common network link. Exemplary embodiments of the flexible banded MUX/DEMUX architecture in accordance with the present invention are illustrated in FIGS. 2-7.

In general, the present invention provides a flexible banded MUX/DEMUX architecture 16 which comprises a coarse demultiplexer layer 18 and a fine demultiplexer layer 20. As shown in FIG. 2, the coarse demultiplexer layer 18 operates to separate two or more spectral bands 22 from an inbound broadband WDM optical signal 8. Each spectral band 22 has a predetermined center frequency and bandwidth, which are selected to encompass a desired plurality of multiplexed channels. For each spectral band 22, a respective fine demultiplexer 24 is provided for separating the respective individual channels 14 of the spectral band 22. As may be appreciated, because the individual channels 14 of each spectral band 22 are demultiplexed by independent fine demultiplexers 24, arbitrarily different spectral grids can be implemented in each spectral band 22.

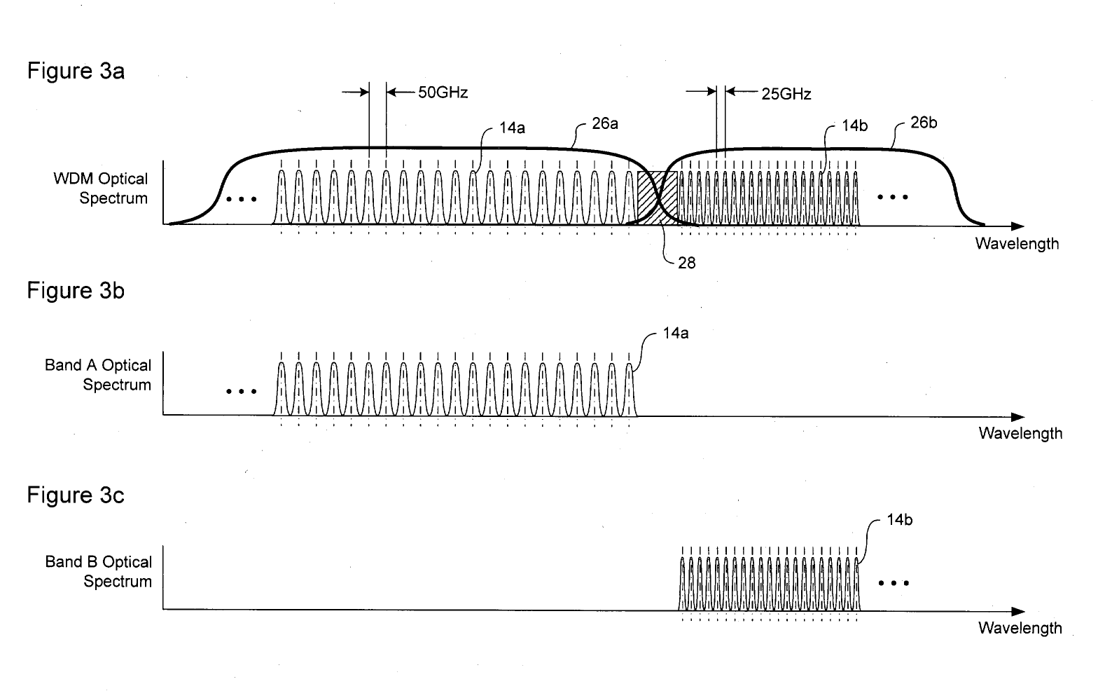

The coarse demultiplexer layer 18 can be implemented in various ways. Typically, a cascade of broadband optical filters (hot shown) will be used, in which each broadband optical filter has a bandpass filter characteristic 26 (see FIG. 3a) that corresponds to at least a portion of a respective spectral band 22. In principal, a broadband optical filter can be provided with a bandpass filter characteristic 26 that spans an entire band 22. For an embodiment having a pair of spectral bands 22, this arrangement yields the structure illustrated in FIG. 2, and the operation illustrated in FIGS. 3a-3c. Thus, a pair of spectral bands 22 are separated from an inbound WDM signal 8 by respective filters of the coarse demultiplexer layer 18, and routed to respective fine demultiplexers 24. In order to avoid cross-talk between the spectral bands 22, a deadband 28 can be provided as shown in FIG. 3a.

As may be appreciated, the use of a single broadband optical filter for each spectral band 22 suffers a disadvantage in that, particularly for very wide spectral bands 22, it may be difficult to obtain a desirably sharp filter cut-off characteristic. This can result in the necessity for an undesirably wide deadband 28 between adjacent spectral bands 22. In addition, any changes in the width of each spectral band 22 would necessarily require changing the filters of the coarse demultiplexer layer 18.

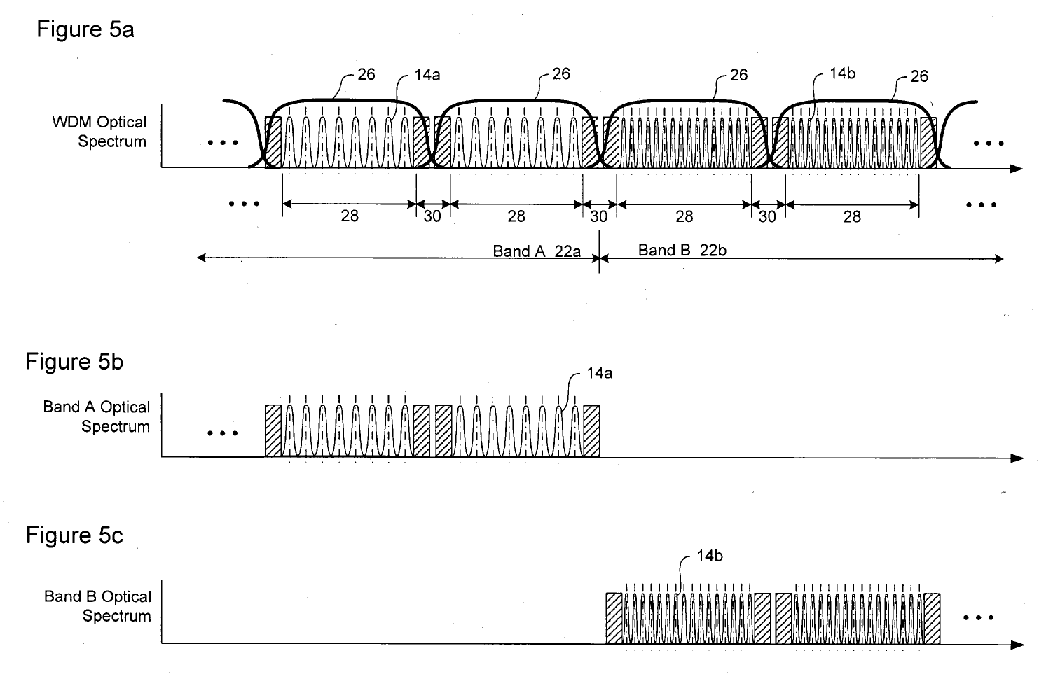

Accordingly, a preferred approach is to provide the coarse demultiplexer layer 18 as a plurality of cascaded broadband optical filters, each of which is designed to isolate a respective portion of the transmission window. Preferably, every optical filter has substantially the same pass band width. For example, the pass band width may conveniently be set equal to 500 GHz, for each optical filter of the coarse demultiplexer layer 18. With this arrangement, the broadband optical filters of the coarse demultiplexer layer 18 operates to divide the inbound WDM signal 8 into a corresponding plurality of channel groups 28. As shown in FIGS. 4 and 5a-d, each channel group 28 can be allocated to a respective spectral band 22, and thus routed to the respective fine demultiplexer 24 for that spectral band. In order to avoid excessive cross-talk between adjacent groups 28, each group 28 can be bracketed by a respective pair of deadbands 30. The width of these deadbands 30 will preferably be selected based on the cut-off characteristics of the optical filters forming the coarse demultiplexer layer 18. For example, for a pass band width of 500 GHz, each deadband 30 may conveniently have a width of about 100 GHz, which leaves about 400 GHz of usable bandwidth within each channel group 28. This approach enables the WDM signal 8 to be divided into two or more spectral bands 22 on a “per channel group” basis. Consequently, the width of each spectral band 22 can be changed as desired, with a minimum granularity of one channel group 28, without having to modify or replace any filters,of the coarse demultiplexer layer 18.

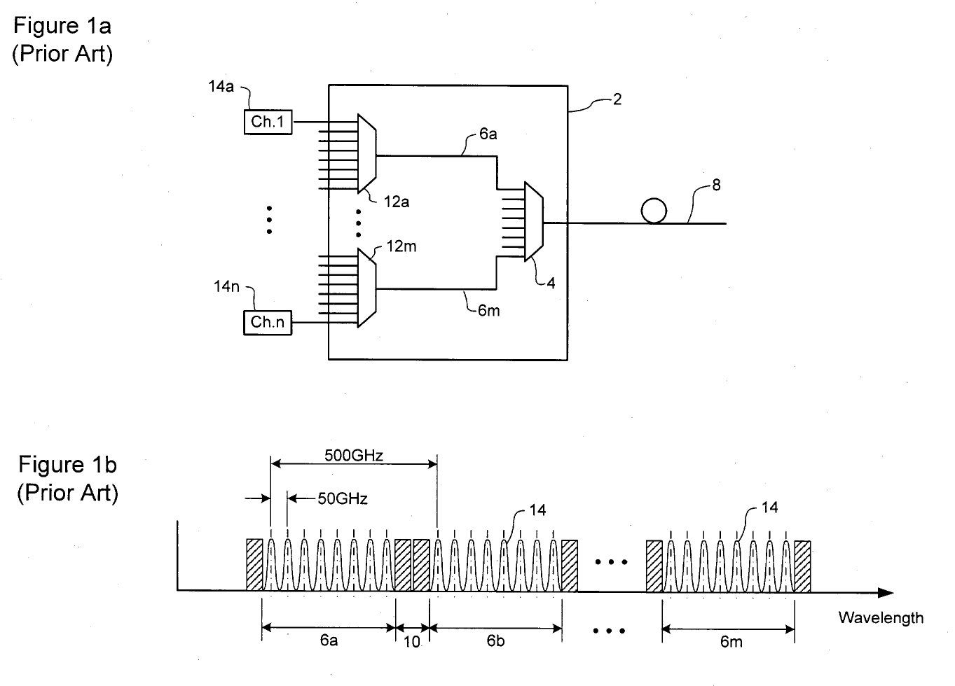

As mentioned above, the fine demultiplexer layer 20 is designed to separate individual channels 14 from each spectral band 22. In the embodiments of FIGS. 2 and 4, this operation is provided by means of a respective array of cascaded optical filters for each spectral band. In the embodiment of FIG. 2, a single filter array is provided for each spectral band 22, while the embodiment of FIG. 4 utilizes a respective filter array 32 for each channel group 28. In either case, the filter arrays of each fine demultiplexer 24 operate independently of those of the other fine demultiplexers 24, so that different spectral grids can be implemented within each spectral band 22. Thus, for example, in the embodiments of FIGS. 2 and 3a-c, the transmission window is divided into a pair of spectral bands 22, nominally referred to as bands A and B. Within band A, channels 14 are provided on a 50 GHz grid. Thus conventional narrowband (50 GHz pass-band width) optical filters can be used to separate each channel from spectral band A. As may be appreciated, this enables legacy network equipment to be used to receive traffic of spectral band A. In the embodiment of FIGS. 4 and 5a-c, the spectral grid of band A corresponds to that of the conventional system illustrated in FIGs. 1a-1b, and described in Applicant's co-pending International Patent Application No. PCT/CA02/00452. Conversely, within band B, channels are distributed on a 25 GHz grid. Modern narrowband (25 GHz pass-band width) optical filters can thus be used to separate each channel from spectral band B.

It will be seen that this arrangement provides a convenient upgrade path for network providers. In particular, legacy (50 GHz channel width) network equipment can be retained in service, and can operate simultaneously with updated (25 GHz) network equipment. Additionally, legacy equipment can be upgraded on a “per channel group” basis. Referring to the embodiment of FIGS. 4 and 5a-c, the allocation of link bandwidth to each spectral band 22 can be adjusted progressively (e.g. on a “per channel group” basis) as demand for link bandwidth changes. Because two or more different spectral grids can co-exist on the same link, new network equipment can be deployed without stranding the legacy equipment.

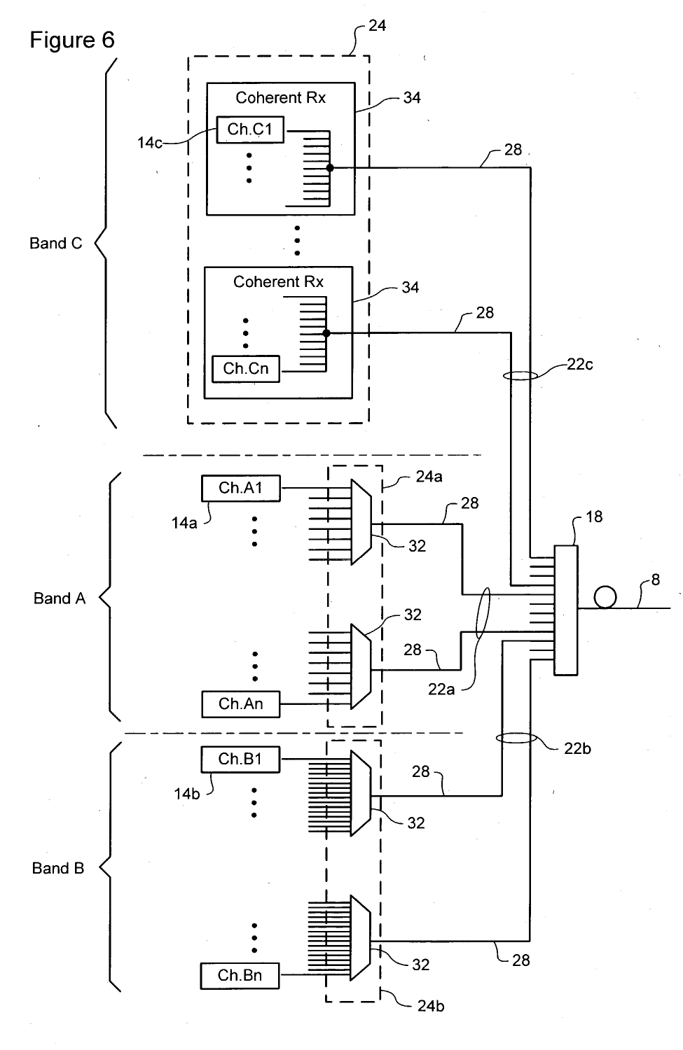

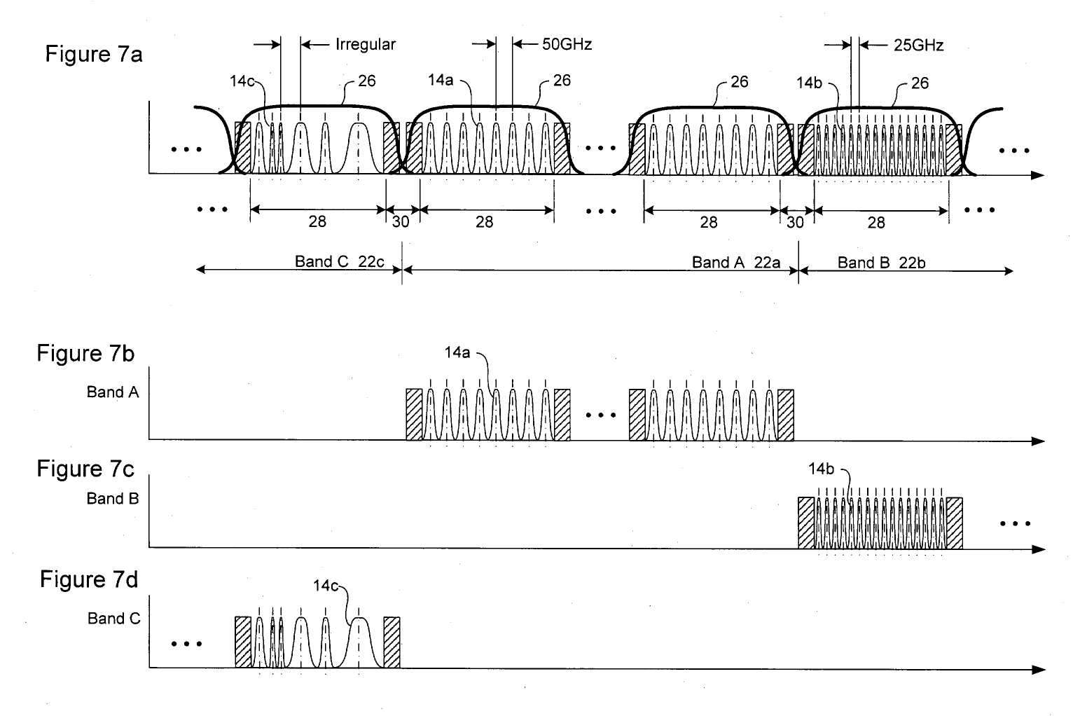

In the embodiments of FIGS. 2-5, uniform (albeit different) spectral grids are implemented within each spectral band 22. Furthermore, in the embodiments of FIGS. 4 and 5a-c, within each spectral band 22, the same spectral grid is implemented within each involved channel group 28. This arrangement is convenient in that it enables conventional narrow-band filter arrays to be used in the fine demultiplexers 24 layer layer. However, it will be appreciated that non-uniform spectral grids may be implemented in one of more bands, if desired. FIGS. 6 and 7a-d illustrate such an embodiment.

As shown in FIGS. 6 and 7a, the embodiment of FIG. 4 can be extended to allocate a desired number of channel groups 28 to a third spectral band 22c, nominally referred to as band C. The involved channel groups 28 are routed to a set of coherent optical receivers 34, each of which is dynamically tunable to receive a desired channel wavelength. As is known in the art, the use of coherent optical receivers 34 obviates the requirement for narrowband optical filters to separate individual channels 14. Instead, each receiver 34 is tuned to detect a respective one channel 14 within the “bulk” optical signal input to the receiver 34. This tuning and selective detection functionality thus constitutes the “fine demultiplexer 24” of the present invention, when applied to the case of coherent optical receivers 34.

As may be appreciated, the use of coherent optical receivers 34 within band C 22c implies that any arbitrary spectral grid may be implemented within that band. Thus, for example, Band C may be provided with a non-uniform mix of high and low bandwidth channels, as shown in FIGS. 7a and 7d. Again, because bands A and B are independently demultiplexed, the presence of non-uniform channel spacings in band C will not cause significant interference in bands A and B. Thus coherent optical receivers 34 can be implemented (and their full range of capability exploited) on the same link as legacy filter-based demultiplexer systems.

The embodiment(s) of the invention described above is(are) intended to be exemplary only. The scope of the invention is therefore intended to be limited solely by the scope of the appended claims.

We claim:

1. A WDM system comprising:
a coarse demultiplexer layer for separating two or more spectral bands from a broadband WDM optical signal, each spectral band including a plurality of multiplexed channels;
a respective fine demultiplexer layer for separating the respective channels of each spectral band;
wherein a respective spectral grid of a first spectral band is different from that of at least one other spectral band.

2. A WDM system as claimed in claim 1, wherein the coarse demultiplexer layer comprises a group demultiplexer for separating two or more channel groups from the broadband WDM optical signal, each channel group having a respective group bandwidth, and being allocated to a respective spectral band.

3. A WDM system as claimed in claim 2, wherein each channel group has the same group bandwidth.

4. A WDM system as claimed in claim 2, wherein a group bandwidth of at least one channel group is different from that of at least one other channel group.

5. A WDM system as claimed in claim 2, wherein each channel group comprises a plurality of channels distributed in accordance with a respective group channel plan.

6. A WDM system as claimed in claim 5, wherein every channel group allocated to one spectral band has the same group channel plan.

7. A WDM system as claimed in claim 1, wherein the group spectral grid of at least one channel group comprises a non-uniform channel spacing.

8. A WDM system as claimed in claim 2, wherein the fine demuitiplexer layer comprises a respective channel demultiplexer layer for separating channels of each channel group.

9. A WDM system as claimed in claim 8, wherein the channel demultiplexer layer comprises any one or more of:
a cascade of wavelength-selective filters; and
a coherent optical receiver.
